(19) United States
(12) Patent Application Publication
(10) Pub. No.: US 2015/0123611 A1
(43) Pub. Date: May 7, 2015

(54) ELECTRIC VEHICLE

(71) Applicant: Shih-Cheng Huang, Kaohsiung (TW)

(72) Inventor: Shih-Cheng Huang, Kaohsiung (TW)

(73) Assignee: ISUDA RECREATION & SPORTS CO., LTD., Kaohsiung (TW)

(21) Appl. No.: 14/401,450

(22) PCT Filed: May 21, 2012
(86) PCT No.: PCT/CN2012/075828

§ 371 Date: Nov. 14, 2014

(51) Int. Cl. B60L 11/18

(52) U.S. Cl. CPC B60L 11/1822
USPC 320/109

(57) ABSTRACT

An electric vehicle is disclosed. The battery unit of the electric vehicle comprises a stationary battery and a removable battery which needs to be exchanged at a battery exchange station. Temporary power shortage problems caused by power supply through a single stationary battery or a single removable battery are solved by power supply through each of or both of the stationary battery and the removable battery.

### FIELD OF THE INVENTION

The present invention relates to an electric vehicle, particularly to an electric vehicle charged in two ways.

### BACKGROUND OF THE INVENTION

The motorcycles of a certain industrial city in Taiwan are to be used as an example to discuss the background of the invention. The number of the motorcycles in the industrial city amounts to 2.26 millions, wherein the number of high-pollution two-cycle motorcycles amounts to five hundred and eighty thousands. All these motorcycles exhaust more than nine thousand tons of volatile organic chemicals each year, which almost equals to the year-round exhaust of a steelwork. Besides, the amount of the greenhouse gas exhausted by each motorcycle each year is about equal to the year-round absorption by fifty trees. Green energy is an inevitable measure to exempt ecology and human bodies from continuing to be endangered by air pollution, and the electric vehicle is an effective approach to popularize green energy.

The current electric vehicle is equipped with a stationary battery, which is directly charged in situ while the power is insufficient. The stationary battery is bulky (normally weighing over 10 kilograms) but only supports a cruising range of only tens of kilometers. If the driver does not notice the status of the battery before driving but finds power insufficiency during driving, it is normally too late to charge the electric vehicle, and the electric vehicle may stop running on the road.

The electric vehicle may alternatively be equipped with removable batteries, which can be replaced with fully-charged batteries in a battery exchange station. Several removable batteries are cascaded or paralleled in an electric vehicle, each normally weighing less than 5 kilograms. The battery exchange station functions like a gasoline station. The driver can go to the nearest battery exchange station to replace the exhausted batteries with fully-charged batteries that can be used instantly.

However, the electric specifications of the removable batteries, such as the energy density (energy per unit mass or per unit volume and the charge rate, are regulated by the responsible unit. Therefore, removable batteries cannot be charged by users themselves but must be charged in a battery exchange station. Owing to the limited cruising range, it may happen that the driver does not yet reach a battery exchange station when the removable batteries are completely exhausted.

The abovementioned problems cause inconvenience to the current users of electric vehicles, make the spectators hesitate to buy electric vehicles, and thus slow down the popularization, of green energy.

### SUMMARY OF THE INVENTION

The primary objective of the present invention is to provide an electric vehicle, which is powered by a battery unit including both the stationary battery and the removable battery, to overcome the problems resulting from the fact that the current electric vehicle is powered by a single stationary battery or a single removable battery.

To achieve the above the abovementioned objective, the present invention proposes an electric vehicle charged in two ways, wherein the battery unit of the electric vehicle comprises a stationary battery directly charged in situ; a removable battery to be replaced in a battery exchange station; a residual capacity display unit showing the residual capacities of the stationary battery and the removable battery; and a switching module switching the stationary battery or the removable battery to power the electric vehicle.

The residual capacity display unit includes a first residual capacity display device and a second residual capacity display device separately electrically connected with the stationary battery is and the removable battery to respectively present the residual electricity storages of the stationary battery and the removable battery. While driving the electric vehicle, the driver selects one of the stationary battery and the removable battery to power the electric vehicle according to their present statuses. For example, while the stationary battery is going to be exhausted, the driver switches the removable battery to power the electric vehicle. Later, the driver will directly charge the stationary battery staying in situ. While the removable battery is going to be exhausted, the driver switches the stationary battery to power the electric vehicle. Later, the driver will go to a battery exchange station to replace the removable battery at an appropriate time. The driver may also switch both the stationary battery and the removable battery to power the electric vehicle simultaneously.

In one embodiment, the present invention proposes an electric vehicle, which is charged in. two ways and has a plurality of removable batteries.

In one embodiment, the present invention proposes an electric vehicle charged in two ways, wherein the battery unit is electrically connected with a residual capacity display unit, and wherein the residual capacity display unit includes a first residual capacity display device electrically connected with the stationary battery and a second residual capacity display device electrically connected with the removable battery.

In one embodiment, the present invention proposes an electric vehicle charged in two ways, wherein a switching module is electrically connected with the stationary battery and the removable battery and switches the stationary battery or the removable battery to power the electric vehicle or switches both the stationary battery and the removable battery to connect in parallel and power the electric vehicle simultaneously.

In one embodiment, the present invention proposes an electric vehicle charged in two ways, wherein a charge jack is electrically connected with the stationary battery.

In one embodiment, the present invention proposes an electric vehicle charged in two ways, wherein the first residual capacity display device and the second residual capacity display device are liquid crystal display devices, light emitting diode display devices, or indicator devices.

Via the abovementioned technical schemes, the present invention has the following advantages:

1. The present invention uses two types of batteries to extend the original limited cruising range.

2. The present invention has two types of batteries, i.e. has two charging ways, whereby the driver is more likely to notice the residual capacities of the batteries and avoid power shortage while driving the electric vehicle.

3. The present invention encourages people to buy electric vehicles and effectively promotes the environment quality.

### BRIEF DESCRIPTION OF THE DRAWINGS

FIG. 1 is a diagram schematically showing an electric vehicle according to one embodiment of the present invention.

FIG. 2 is a block diagram schematically showing the circuit of an electric vehicle according to one embodiment of the present invention.

FIG. 3 is a diagram schematically showing that the batteries of a battery unit are respectively charged and exchanged according to one embodiment of the present invention.

### DETAILED DESCRIPTION OF THE PREFERRED EMBODIMENTS

Below, the embodiments are described in detail in cooperation with the attached drawings to make easily understood the objectives, technical contents, characteristics and accomplishments of the present invention.

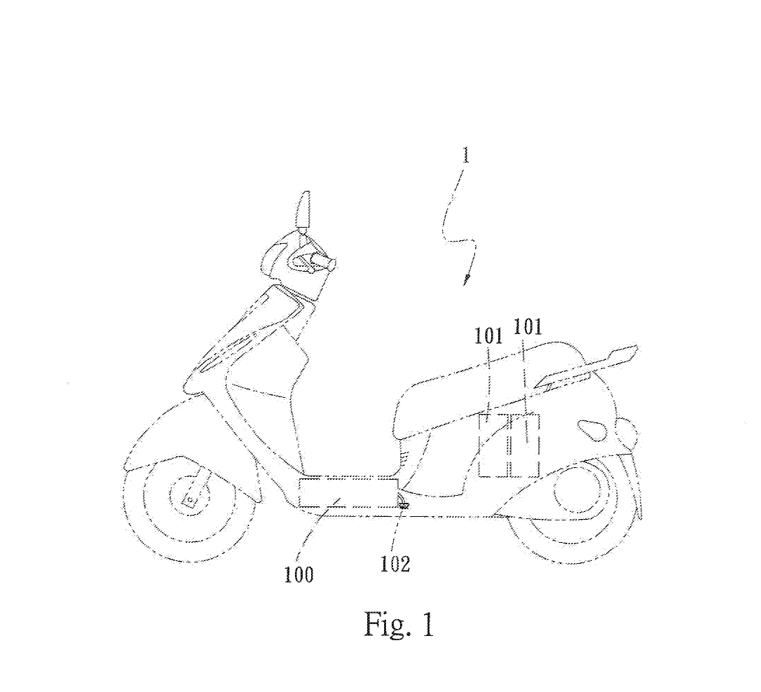

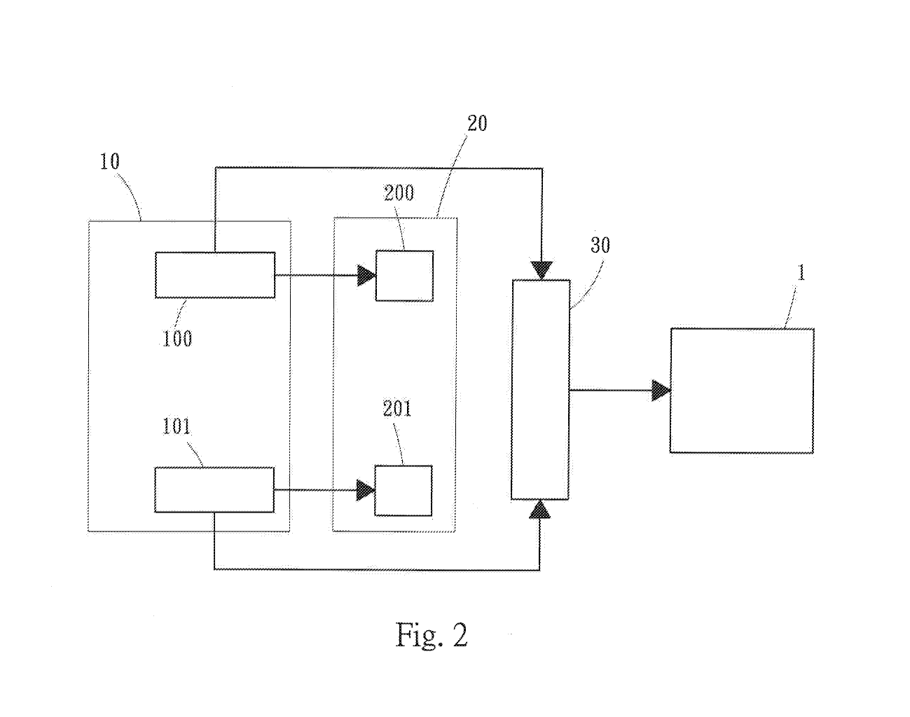

FIG. 1 is a diagram schematically showing an electric vehicle according to one embodiment of the present invention. FIG. 2 is a block diagram schematically showing the circuit of an electric vehicle according to one embodiment of the present invention. In the specification, a motorcycle is used to exemplify the electric vehicle of the present invention. The electric vehicle 1 of the present invention comprises a battery unit 10. The battery unit 10 further comprises a stationary battery 100 directly charged in the electric vehicle 1; a removable battery 101 to be replaced in a battery exchange station; a residual capacity display unit 20 showing the residual capacities of the stationary battery 100 and the removable battery 101; and a switching module 30 switching the stationary battery 100 or the removable battery 101. to power the electric vehicle 1,

The stationary battery 100 is disposed in the front lower portion of the electric vehicle 1, i.e. the region where the rider places his feet. The removable battery 101 is disposed inside the storage compartment below the seat of the electric motorcycle. The electric vehicle 1 of the present invention may adopt several removable batteries 101, whose number depends on the size of the storage compartment.

The residual capacity display unit 20 is disposed on the middle region of the handlebar of the electric motorcycle, whereby the rider can easily view the residual capacity display unit 20. The residual capacity display unit 20 includes a first residual capacity display device 200 and a second residual capacity display device 201 respectively connected with the stationary battery 100 and the removable battery 101 to present the residual capacities of the stationary battery 100 and the removable battery 101. The first residual capacity display device 200 and the second residual capacity display device 201 are liquid crystal display devices, light emitting diode display devices, or indicator devices.

In one embodiment, the switching module 30 is a switch disposed in a region near the handlebar of the electric motorcycle, where the rider can operate the switch conveniently The rider operates the switching module 30 to establish an electric connection and determine whether the stationary battery 10, the removable battery 101 or both of them supply power to the electric vehicle 1.

Refer to FIG. 2 again. As shown in FIG. 2, the stationary battery 100 and the removable battery 101 of the battery unit 10 are respectively electrically connected with the first residual capacity display device 200 and the second residual capacity display device 201 of the residual capacity display unit 20. The switching module 30 is responsible for determining whether the stationary battery 100, the removable battery 101 or both of them supply power to the electric vehicle 1.

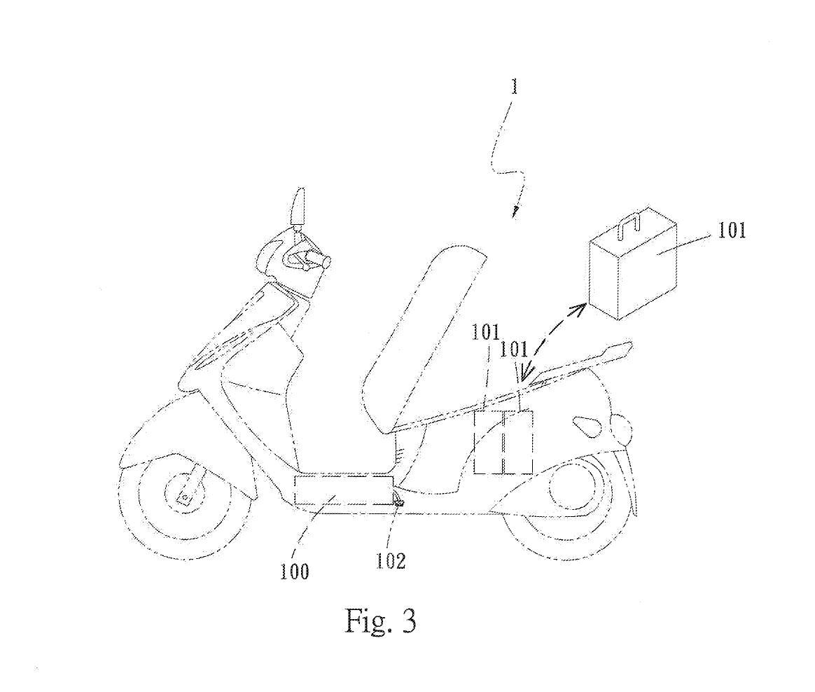

Refer to FIG. 3, and refer to FIG. 2 again. While the first residual capacity display device 200 of the residual capacity display unit 20 indicates that the power of the stationary battery 100 is going to be exhausted, the rider of the electric motorcycle uses the switching module 30 to switch the removable battery 101, which still has sufficient power storage, to supply power to the electric motorcycle. After the return trip, the rider connects a power source to a charging jack 102, which is electrically connected with the stationary battery 100, to directly charge the stationary battery 100. While the second residual capacity display device 201 indicates that the power of the removable battery 101 is going to be exhausted, the rider of the electric motorcycle uses the switching module 30 to switch the stationary battery 100, which still has sufficient power storage, to supply power to the electric motorcycle. Then, the rider immediately goes to a battery exchange station to replace the exhausted removable battery 101 with a fully-charged removable battery 101. The rider can also operate the switching module 30 to switch both the stationary battery 100 and the removable battery 101 to work in a parallel mode to power the electric motorcycle, whereby the cruising range of the electric motorcycle is also increased.

In conclusion, the coverage of the electric vehicle of the present invention includes electric automobiles, electric motorcycles, electric bikes and other vehicles power by electricity. The present invention is characterized in that the electric vehicle is simultaneously equipped with two types of batteries respectively charged in two different ways and powered by a single one of them or both of them. The present invention solves the problem that the conventional electric vehicle is equipped with only a stationary battery or a removable battery. The electric vehicle of the present invention enjoys the advantages of both types of batteries, exempts the users from a lot of inconveniences and troubles, encourages people to buy electric vehicles, and improves the quality of air.

What is claimed is:

1. An electric vehicle, comprising a battery unit, wherein the battery unit includes
a stationary battery installed in the electric vehicle and directly charged in the electric vehicle by a power source connected with the electric vehicle; and
a removable battery installed in the electric vehicle and replaced with a fully-charged removable battery in a battery exchange station.

2. The electric vehicle according to claim 1 whose battery unit includes a plurality of removable batteries.

3. The electric vehicle according to claim 2, wherein the battery unit is electrically connected with a residual capacity display device, and wherein the residual capacity display unit further includes a first residual capacity display device electrically connected with the stationary battery and a second residual capacity display device electrically connected with the removable battery.

4. The electric vehicle according to claim 3, wherein a switching module is electrically connected with the stationary battery and a removable battery, and wherein the switching module is a switch selectively switching the stationary battery, the removable battery, or both of the stationary battery and the removable battery to power the electric vehicle.

5. The electric vehicle according to claim 4, wherein a charging jack is electrically connected with the stationary battery.

6. The electric vehicle according to claim 5, wherein the first residual capacity display device and the second residual capacity display device are liquid crystal display devices, light emitting diode display devices, or indicator devices.
